(19) United States
(12) Patent Application Publication
(10) Pub. No.: US 2003/0031861 A1
(43) Pub. Date: Feb. 13, 2003

(54) Label with enhanced anticounterfeiting security

(76) Inventors: Sven Reiter, Hamburg (DE); Arne Koops, Breitenfelde (DE); Christian Harder, Hamburg (DE); Hans Karl Engeldinger, Quickborn (DE)

Correspondence Address: KURT BRISCOE, NORRIS, MCLAUGHLIN & MARCUS, P.A., 220 EAST 42ND STREET, 30TH FLOOR, NEW YORK, NY, 10017, US

(21) Appl. No.: 10/140,653

(22) Filed: May 8, 2002

(30) Foreign Application Priority Data
Aug. 11, 2001 (DE) 101 39 653.8

(51) Int. Cl. B32B 7/12

(52) U.S. Cl. 428/343

(57) ABSTRACT

A label with enhanced proof against counterfeiting, comprising at least one carrier layer with an adhesive layer on its underside, wherein the adhesive layer is composed of a pressure sensitive and/or hotmelt adhesive and a heat-activatable (reactive) adhesive.

The invention relates to a label with enhanced proof against counterfeiting, comprising a carrier layer, especially varnish layer, very particularly of thermoset varnish for laser inscription, with an adhesive layer on the underside of the carrier layer.

For the identity marking of parts on vehicles, machinery and, electrical and electronic devices, use is being made increasingly of technical labels as, for instance, model identification plates, process control labels, guarantee badges, and testing plaquettes.

Inherent in many of these applications is the need for a more or less pronounced degree of proof against counterfeiting. This proof applies primarily to the period of attachment and to the total period of use on the part to be marked. Removal or manipulation ought to be impossible without destruction, or visible, irreversible alteration. In order to increase further the proof of the labels against counterfeiting the labels themselves are increasingly being required to make a contribution to security by means of a particular design.

In especially sensitive areas of application there must also be a security stage for the production of the labels. If it were too easy to acquire and mark such labels and to produce copies, third parties would be able to carry out unauthorized circulation of articles.

This additional proof against counterfeiting must, however, not hinder subsequent identification with the applied labels for originality by means of a rapid, unambiguous, simple and nondestructive method. Identity marking by means of laser labels is acquiring increasing priority particularly in the automotive industry, especially for high-value marking. It is used to place data and advisory information, such as tire pressure or fuel type, on a wide variety of components of the automobile for the benefit of its subsequent user. In the upstream manufacturing stages as well, important production data may be conveyed by way of a laser label.

For this application, the label may be inscribed with a barcode. A suitable reader device enables an assembly team to read off information on model, color, and special equipment from the barcode directly on the production line.

Not only this standard information, however, but also sensitive security data such as chassis number and vehicle identification number are positioned on the vehicle by means of labels. In the case of theft or accident, this information is of great importance for tracing both vehicle and manufacturing stages.

Owing to the costs of acquiring a laser inscription unit, which are high in comparison to those for conventional label printing systems, for many criminal organizations the direct copying of the plate information is not an option. Counterfeits produced by conventional printing processes are easy to recognize. For this reason, attempts are often made to detach the plate information from vehicles and reapply it to other vehicles.

If detached, a label can easily be used to give a stolen vehicle a different identity (new chassis number). As a result, tracing the vehicle is virtually impossible.

In order to counter attempts at manipulation, therefore, the label material used must be extremely counterfeitproof. It must not be nondestructively detachable from the bond substrate.

Additional security is achieved by a combination of a very fragile material with high bond strength. The bond strength of the material to the substrate plays an important part, and is critical for resisting any attempts at manipulation by detachment. As well as the standard material there are modified labels, which are intended to make it impossible to copy material by virtue of additional security features such as embossment, holograms, or a permanent UV impression (footprint).

High-performance controllable lasers for burning marks such as text, codes, and the like are widespread. The requirements imposed on the material that is to be inscribed include the following:

It should be capable of rapid inscription.

A high degree of spatial resolution capability should be achieved.

It should be extremely simple to use.

The decomposition products should not be corrosive.

For special cases, moreover, additional features are called for:

The laser-produced indicia should have sufficiently high contrast to be legible without error at a distance even under unfavorable conditions.

Heat resistance should be high; for example, up to more than 200° C.

Resistance to weathering, water, and solvents is desired.

Known materials used for this purpose, such as printed paper, Eloxed aluminum, painted metal or PVC sheets, do not meet all of these requirements.

DE U 81 30 861 discloses a multilayer label comprising a thin and a thick, self-supporting, opaquely pigmented varnish layer. Both layers are composed of a solventlessly applied and electron beam cured varnish, the layer thicknesses being different. The label is inscribed by using a laser to burn away the upper, thinner varnish layer, so that the lower, thicker varnish layer becomes visible, said lower layer preferably being of a contrasting color to the first layer.

This inscription is a kind of gravure, ruling out possibilities for manipulation as exist with traditional imprints using inks. As a result of the base materials used and the production process, the label is made so brittle that its removal from the substrates without destruction is virtually impossible.

Laser labels of this kind are employed in particular for rational and variable inscription for the purpose of producing plate sets. These plate sets contain the total number of labels needed, for example, on components that require labeling in a motor vehicle (VIN plate, plates relating to tire pressure, trunk loading, key data for engines and ancillary equipment, etc.).

As far as proof against counterfeiting is concerned, a laser sheet such as is known from DE U 81 30 861 and is available, for example, as tesa 6930 ® from Beiersdorf, is a product with a very brittle structure which gives it a good basis for documenting, and hence frustrating, any attempts at manipulation.

Nondestructive removal of the laser-inscribed label in one piece from its original bonding substrate requires a great deal of effort and particular conditions.

This effort is so great that said label easily passes all current detachability tests by the major testing institutions, such as, for example, “Prüfung von Fabrikschildern aus Platten, Blechen und Folien sowie deren Befestigung durch Kleben” [Testing of plant plates made from plaques, metal sheets, and foils, and their fastening by adhesive bonding] by the German motor transport office, and “Marking and Labeling System Materials MH 18055” by Underwriters Laboratories Inc..

This certified proof against counterfeiting, which must always be seen in relation to the effort needed for manipulation, is having to face up to heightened requirements concerning proof of originality. This means that by means of a bonded laser label it should be documented that the marked component is an original. Since, as already mentioned earlier, both the laser sheet and laser inscription units are freely available on the market, there exists here a possibility for organized criminality on a large scale. Using the aforementioned hardware and the freely available laser sheets, stolen vehicles can be furnished with new labels which are difficult if not impossible to distinguish from the actual original labels.

EP 0 645 747 A specifies a laser-inscribable, multilayer label material composed of a first layer and a second layer which is optically different from the first layer, said first layer being removable by means of laser radiation in accordance with a desired text image or print image, in the course of which the surface of the second layer is rendered visible. Disposed between the layers, furthermore, is a transparent polymer sheet which forms a carrier layer.

DE 44 21 865 A1 specifies a monolayer laser label comprising a carrier layer made of plastic, said layer comprising an additive which changes color under laser irradiation.

The carrier layer is coated on one side with a self-adhesive composition which where appropriate is covered with a release paper or release film.

DE 199 09 723 A1 discloses a security sheet which has a carrier layer contained within which there is an identification medium. By means of a contactless inscription process it is possible to deliberately bring about selective and local changes in the diffusion properties of this identification medium. Where the security sheet thus inscribed is adhered to a workpiece, the identification medium diffuses toward the substrate surface where it brings about a detectable reaction. This diffusion and/or reaction occurs only in those regions of the substrate surface where diffusability has been initiated, or unhindered, by the inscription procedure. Consequently, the security sheet allows unambiguous inscribing and identification of the workpiece.

The security sheet is inscribed by means of a contactless process. Accordingly, a rapid and flexibly variable inscription which is insensitive to soiling can be achieved even in the plant environment. The inscribing of the security sheet, and hence the change in the diffusion properties of the identification medium, may be done in particular by means of electromagnetic radiation. To inscribe the security sheet it is particularly advantageous to use a laser which allows both temperature-sensitive and light-sensitive inscription (as used here, “light” embraces the entire range of the electromagnetic spectrum that is available to the laser). Lasers have the further advantage of enabling high-contrast inscriptions with a free choice of pattern, of allowing rapid changes to the pattern inscribed, and of process reliability in use in the plant environment.

All of the labels set out above, following applications of an article, provide a high level of proof against counterfeiting, since the labels can be inscribed only with technically refined lasers which are therefore expensive and not universally accessible, with the consequence that the equipment needed to copy or alter said labels has generally been more expensive—at least in the past—than the product in question. Moreover, the brittleness of the material results in destruction of the label in the case of attempts at manipulation or removal.

With the progress of technology, however, lasers of this kind have come evermore favorable, so making it worthwhile in an increasing number of cases to acquire such lasers, particularly in the case of relatively large products such as, for example, motor vehicles which are provided with such a label for the purpose of identity marking in the engine compartment as well as elsewhere.

In this situation, the production of unauthorized copies is made much easier by the ready and freely accessible supply of laser label stock and the existence, now widespread, of laser inscription units.

Using flat, sharp blades, moreover, it is possible to separate labels completely from the substrate. Particularly on plastics substrates such as polyethylene or polypropylene, the bond between adhesive and substrate shows weaknesses.

Despite increased bond strength on metallic or painted substrates, it is possible there as well to detach some of the labels without destroying them, by using special tools. A special bladed tool can be guided at a shallow angle beneath the label. By means of careful cutting movements it is possible to lift one edge, so producing what is termed a grip tab. In this way a point of attack is produced which makes detachment easier.

In addition, there is a continual requirement not only to prevent counterfeits and the dissemination of copies but also to individualize the label, for use particularly in an automobile, for a specific customer and to supply it exclusively to that customer.

This individualization has to meet two important criteria, namely

the label must be readily and rapidly identifiable, and

the label must be uncopyable.

By means of these two criteria it is possible to ensure that only the proper authority, in this case the automaker, is able to define and identity-mark components as originals.

First attempts at individualizing the carrier material of the label are disclosed in DE 199 04 823 A1. It describes a process for producing a sheet, in which first of all a support foil is embossed by means of an embossing tool, the embossing tool having holographic structures. A sheet is then produced on the embossed support foil so that at least one hologram is reproduced on the sheet.

It is an object of the invention to provide a label which meets the abovementioned requirement of enhanced proof against counterfeiting, and in particular to enhance the proof of the laser-inscribable sheet against counterfeiting by modifying the adhesive, to improve the composite properties of the sheet in such a way that, even using a cutting tool, it is impossible to carry out nondestructive detachment of a bonded label, said label further possessing, in particular, a high contrast, high resolution capability, high temperature stability, and ease of use.

This object is achieved by means of a label as described in the main claim. The subclaims provide particularly advantageous embodiments of the subject matter of the invention, and also provide for its use.

The invention accordingly provides a label with enhanced proof against counterfeiting, comprising at least one carrier layer with an adhesive layer on its underside. The adhesive layer is composed of a pressure sensitive and/or hotmelt adhesive and a heat-activatable (reactive) adhesive.

In one outstanding embodiment of the label the adhesive layer comprises a mixture of the pressure sensitive and/or hotmelt adhesive with the heat-activatable adhesive.

Further advantageously, the adhesive layer comprises the pressure sensitive and/or hotmelt adhesive and the heat activatable adhesive arranged alternately in stripes.

In this case the heat-reactive adhesive forms a bridge between carrier layer and bonding substrate, so that on activation the reactive adhesive has a direct connection to both.

In addition to the arrangement of the adhesives in the form of stripes, however, all other partial geometric arrangements and forms are possible, especially dot formations, with varying distances between the adhesives etc.

The selection of the arrangement is guided by the particular end use and site of use of the labels.

In a further embodiment the reactive adhesive is laminated or printed in partial stripes or dots onto the carrier layer, in particular the laser varnish layer. The adhesive is then coated onto the modified carrier layer in a second coating step.

The advantage of this variant lies in the permanent tack over the whole area.

A further advantageous embodiment, then, is one wherein, in the adhesive layer, the heat activatable adhesive is laminated, printed, placed or adhered onto the pressure sensitive and/or hotmelt adhesive, in particular in the form of stripes and/or dots.

In one advantageous embodiment of the invention the label is composed of

a) a carrier layer made of plastic and

b) comprising an additive which under laser irradiation exhibits a marked change in color, said layer

c) being coated on one side with an adhesive composition composed of a pressure sensitive and/or hotmelt adhesive and a heat activatable adhesive and

d) where appropriate covered with a release paper or release film.

The carrier layer has a thickness of preferably from 10 to 200 μm, in particular from 50 to 100 μm.

Suitable carrier layers are composed, moreover, of plastics such as polyesters, poly(meth)acrylates, polycarbonate, and polyolefins, and of radiation curable systems such as unsaturated polyesters, epoxy acrylates, polyester acrylates, and urethane acrylates, such as are also used for UV printing inks, especially those comprising a base polymer according to DE U 81 30 861, namely aliphatic urethane acrylate oligomers.

The additive may be a pigment, especially copper hydroxide phosphate or Iriodin, and titanium dioxide may be used as well as the additive.

Suitable additives are, in particular, color pigments and metal salts, especially copper hydroxide phosphate or else Iriodin, a pearl luster pigment available commercially from Merck. These additives are admixed to the base polymer (as described, for example, in DE U 81 30 861) in particular in an order of magnitude ranging from several parts per thousand up to a maximum of 10% by weight, preferably in amounts from 0.1 to 10% by weight, in particular from 0.5 to 5% by weight, based on the total weight of the carrier layer. Following production of sheet material by means of known techniques such as extrusion, casting, coating, etc. with subsequent radiation-chemical crosslinking where appropriate, such films are coated with the adhesive layer.

Covering with siliconized release paper then produces the typical construction for stock material from which labels can be manufactured.

When the standard lasers are used, especially the widespread solid state Nd-YAG lasers with a wavelength of 1.06 μm, a (marked) change in color takes place at the point where the laser strikes the surface of the material, giving sharply defined, high-contrast inscriptions and identity markings.

In a further advantageous embodiment the carrier layer is composed of a varnish, in particular of a cured varnish, preferably a radiation cured varnish, with particular preference an electron beam cured polyurethane acrylate varnish. In one alternative embodiment the carrier layer is composed of a polybutylene terephthalate.

With further preference, an outer, especially self-supporting, opaquely pigmented varnish layer is applied, preferably solventlessly, to the top side of the varnish layer, i.e., the side opposite the side to which the adhesive layer has been applied, and is subsequently subjected, in particular, to electron beam curing.

The top varnish layer, formed from a cured, i.e., crosslinked, varnish, has a thickness of preferably from 1 to 20 μm, in particular from 5 to 15 μm; the varnish layer has a thickness of preferably from 20 to 500 μm, in particular from 30 to 100 μm.

In principle, four types of varnish can be used provided their stability is adequate; for example, acid curing alkyl-melamine resins, addition crosslinking polyurethanes, free radically curing styrene varnishes, and the like. Particularly advantageous, however, are radiation curing varnishes, since they cure very rapidly without laborious evaporation of solvents or exposure to heat. Varnishes of this kind have been described, for example, by A. Vrancken (Farbe und Lack 83, 3 (1977) 171).

In one preferred embodiment the two varnish layers have a maximum color contrast to one another.

This is because the label of the invention is composed preferably of an opaque top layer, which can be easily burnt through by a laser beam, and a bottom layer, in particular in a contrasting color to the first, the bottom layer being such that it is not easily burnt through by the laser beam.

It has proven particularly advantageous if the respective varnish layer contains at least 5% by weight, preferably 7% by weight, of an additive which is fluorescent or phosphorescent or which is suitable for magnetic or electrical characterization.

In another advantageous embodiment, either the varnish layer or the second varnish layer is printed with an ink comprising a fluorescent or phosphorescent additive in such a way that in the finished label the ink layer is between the two varnish layers.

In the case of two-layer and multilayer labels, a suitable additive may be incorporated into the varnish layer that is decisive for the text. The outer varnish layer itself, for the high gloss model identification plates, for example, therefore remains unchanged; only at the later engraving stage is the varnish layer partially exposed at the sites of the inscription. Where the varnish layer—white, for example—includes color pigments, color particles, colored fibers, and the like, these become visible at the engraved sites.

The color-imparting particles may comprise fine color pigments or else, preferably, visible particles with a size of the order of from 0.1 to 5 mm. The use of finely ground color pigments produces a slight change in shade of the indicia, the visible particles a characteristic color mosaic. Absent auxiliaries, the use of daylight fluorescent inks allows the “fingerprint” to be seen, which is often undesirable. It is therefore preferred to use color pigments or particles which do not absorb in the range of visible light and hence are normally invisible—only when the label is illuminated with a lamp of appropriate wavelength are the color pigments excited and luminesce characteristically.

Besides color pigments excited by means of IR radiation, primarily UV-active systems are employed. Also suitable in principle are luminescent substances which are excited by electron beams, X-rays and the like, and also thermochromic pigments which undergo a reversible color change as a response to a change in temperature—in these cases, however, carrying out an identification procedure on the bonded label is awkward in practice and more complicated than visualization by means of light of an appropriate wavelength.

When selecting the color pigments it should be ensured that they are sufficiently stable for the label production process (film production, adhesive coating) and do not undergo irreversible alteration under the process conditions (possibly thermal drying, electron beam or UV curing, and the like). For long-term applications of the labels it is advantageous for these luminescent substances, which are generally sensitive, to be embedded in a polymer matrix and additionally protected by the cover layer. Additional measures to counter mechanical abrasion, and protection against direct oxygen and water contact, are unnecessary.

For use in accordance with the invention it is possible to employ a variety of color pigments and dyes. The most widespread are long-afterglow (phosphorescent) pigments or fluorescent pigments which are excited solely or predominantly by UV radiation and which emit in the visible region of the spectrum (as an overview, see, for example, Ullmann's Enzyklopädie der technischen Chemie, 4th edition, 1979, Verlag Chemie). Also known, however, are IR-active luminescent pigments. Examples of systems featuring UV fluorescence are xanthenes, coumarins, naphthalimides, etc., sometimes referred to in the literature under the rubric of “organic luminescent substances” or “optical brighteners”. The addition of a few percent of the luminescent substances in question is sufficient, with binding into a solid polymer matrix, in particular, being favorable in respect of luminosity and stability. Use may be made, for example, of formulations comprising RADGLO® pigments from Radiant Color N.V., the Netherlands or Lumilux® CD pigments from Riedel-de Haën. Inorganic luminescent substances are also suitable; metal sulfides and metal oxides, generally in conjunction with appropriate activators, have proven favorable as long-afterglow substances, particularly with emission of light in the yellow region. These substances are available, for example, under the tradename Lumilux® or, as luminescent pigments improved in respect of stability, luminosity and duration of afterglow, under the tradename LumiNova® from Nemoto, Japan.

These dyes and color pigments, listed by way of example, are incorporated into the formulation of the respective varnish layer in amounts of from 0.1 to 50% by weight, preferably at from 1 to 25% by weight, with very particular preference at 7% by weight, and the varnish layer is applied. Following final adhesive coating of the varnish layer and, where appropriate, lining with release paper or release film, the label stock material is available for customer-specific utilization.

After punching/laser cutting of the desired label geometries, and final inscription by means of a laser beam with text, barcodes, logos, etc., the label is present in its final form. If, for example, long-afterglow pigments have been incorporated into the varnish layer, upon corresponding excitation of the luminescent pigments the label displays a characteristic afterglow in the region of the laser inscription and at the edges, permitting its easy and rapid identification as an original label. Apart from the specific light source and, where appropriate, eye protection to counter disruptive ambient light, no other expensive equipment is needed—following testing, the label remains unchanged.

Labels of this kind, comprising luminescent substances—especially those which emit in the visible wavelength range only after UV or IR excitation—in the varnish layer, are also suitable for in-register production (printing, punching, application, etc.). Instead of separately applying register marks or control marks, the light emission of the varnish layer can be utilized for this purpose in processing: in particular following inscription and cutting of the labels by means of a laser beam from unpunched roll material, the excitation and emission can be utilized in a downstream control unit with appropriate equipment, at a defined point on the label, as a control mark for further processing steps or for producing the next label.

Alternatives for the use of luminescent substances include the incorporation into the varnish layer of substances which can be detected magnetically or electrically, and also thermochromic pigments which undergo a reversible color change in response to a change in temperature. Magnetic field changes as in the case of alarm labels for articles of clothing, for example, are possible in principle although not predestined for the fields of application (identity marking of machinery parts and automotive parts predominantly made of metal).

On the other hand it is appropriate, as a hidden security step, to add substances to the varnished layer that lead to said layer having electrical conductivity. By means of suitable measuring equipment, which is transportable, easy to use, and inexpensive to purchase, and suitable electrodes, the conductivity of the varnished layer can be determined directly on the bonded label. The electrodes are attached at two different points, A and B, of the varnished layer, and a voltage is applied. If there is a coherent electrical conductivity between A and B, it is possible to measure a current flow which may have a characteristic value in dependence on the nature and amount of the additive used. Since, even when the label is used directly on metals, the varnish layer is separated from the conductive metal by the electrically insulating adhesive layer, there is no risk of erroneous measurements.

Falsification by subsequent manipulation is prevented in particular by the fact that the conductivity measurement may be made not only from edge to edge of the labels but also between any desired points exposed by laser treatment.

To allow conductivity to be detected here, the complete varnish layer must be coherently and three-dimensionally conductive, which can only be ensured as part of the original production process. A laser-inscribable label of this kind can be produced by adding electrically conductive substances to the formulation of the varnish layer; this may be done in addition to the existing pigments or else at least partly in replacement of the pigments present, in order to attain the good processing properties of the varnish pastes. Suitable conductive additives include in principle electrically conductive metallic, organic, polymeric, and inorganic substances, preference being given to the use of metals. Especially for white or pale varnish layers, the inherent color of the conductive additive is a factor in selection. Conductive carbon black is likewise suitable, albeit only for black or dark varnish layers.

In order to ensure good conductivity, there should be a minimum, limit concentration of additive, so that sufficient particles are present in the varnish layer to touch and have contact with one another. Below this limit concentration, a conductive path from A to B is no longer ensured in the three-dimensional microstructure of the base layer. It is therefore preferred to use metallic particles, preference being given to fibers having a high ratio of length to cross section, since in this case it is possible to ensure three-dimensional conductivity with lower concentrations than with spherical particles; additionally, the alteration in color of the varnish layer by the fibers is reduced. From cost/benefit analysis, the metals used are preferably copper, iron, aluminum, and steel, and the alloys of these metals, although expensive, highly conductive metals such as silver and gold are suitable as well. The fiber dimensions are from 0.1 to 50 mm length with cross sections of from 1 to 100 μm, preference being given to using metal fibers having a diameter of from 2 to 20 μm with a cross section-to-length ratio of approximately 1:100 to 1:1000. Such fibers are incorporated homogeneously into the known formulation at from 0.5 to 25% by weight, preferably from 2 to 10% by weight, and the formulation is applied and cured in accordance with DE U 81 30 861.

Following adhesive coating and lining with release paper, the label material can be inscribed by laser beam. As a result of the removal of the top varnish layer, the indicia of the varnish layer are exposed in the region of laser inscription—when a voltage is applied by way of suitable electrode contact to two different points A and B in these indicia, a conductivity is measured which is characteristic of the varnish layer and is determined by, inter alia, the nature and amount of the conductive additive. Hence it is possible to produce customer-specific label stock material by means of defined formulations.

This additional marking is invisible from the facing side in the region of the inscription (except in the case of a transparent or translucent layer), and can only be seen at the edge, around the label. In order to ensure clear visibility at the label edge, strongly luminescent color inks are printed in a sufficient layer thickness. Despite this, the additional security is hidden and therefore unapparent. This security marking is protected from external access by the fact that the print lies embedded between the label sheet and the adhesive layer: there is no risk of subsequent manipulations, since detachment of the known laser labels is impossible without destruction of the varnish film.

Customer-specific “fingerprints” in the labels can be produced by printing different colors or patterns. In particular, regular lines and line patterns produce characteristic patterns of luminescent dots at the label edges, and are also particularly inexpensive and economical with material. Following punching or laser cutting of the label and application to the bonding substrates, and given an appropriate source of illumination, a pattern which is characteristic in terms of colors and geometry is evident at the edge of the label.

The advantage of this security marking is manifested especially from a logistical standpoint and in terms of costs. It is possible to employ commercial printing inks and unspecific label sheet material, with the latter being otherwise producible customer-specifically. Since standard stock material of this kind is only used as an intermediate by the label manufacturers themselves for their own production, and is not freely available on the market, however, unauthorized access is prevented. Moreover, small batch sizes and short supply times are possible.

In one inventive embodiment of the label use is made, for example, of the two-layer sheet material described in DE U 81 30 861. Prior to coating and lining with release paper, the reverse is printed over the whole area, in an endless pattern or, in particular, with defined geometries. Printing inks containing a high fraction of luminescent pigments are applied preferably by screen printing so as to give film thickness in the range from 0.5 to 50 μm, preferably from 2 to 25 μm.

Following adhesive coating and lining, the label stock material is punched or cut by laser beam to the desired formats and sizes. In the bonded state these labels give no indication of a hidden falsification step provided the luminescent materials chosen emit light as a result of excitation with light outside the visible region; only following irradiation with suitable light sources does excitation of the luminescent pigments take place at the edges of the label. Here, and here only, therefore, markings are visually perceptible which result in a defined pattern of luminescent dots. The size of the luminescent dots can be varied by means of different line widths and line heights. Accordingly, a readily detectable security stage can be realized simply, cost effectively, and, where necessary, customer-specifically by way of the selection of geometry and colors.

Preference is further given to an embodiment of the label which is composed of at least one varnish layer obtainable by applying the varnish layer—preferably solventlessly—to a printed or embossed support carrier sheet, and then curing it. Furthermore, a hologram may be applied to the varnish layer.

It has proven advantageous if the varnish layer is self-supporting and opaquely pigmented and also if the varnish layer is electron beam cured.

It has also proven advantageous if the support carrier sheet is a polymer film, in particular a polyester film.

The support carrier sheet is printed in particular by the flexographic process, since the UV flexographic printing process possesses a very high degree of freedom in terms of the design of geometries and is able to provide good print quality at a very low price particularly for web materials ranging from paper to film. With this technology it is possible to transfer lines, fields, images, logos, text, etc. from printing plate to printing substrate, in different sizes and kinds.

The most important factors influencing this process are:

prepress stage (reprographic elaboration of the printing plate)

printing plate

print format construction

material to be printed

engraved roller

printing ink

coloring

print tension

In the above-described application of the counterfeitproof, laser-inscribable label, logos and text of varying complexity are preferentially required by automakers; UV flexography is very suitable here.

For this purpose, a printing plate bearing the logos and text is wetted with printing ink, which is transferred to a polymer film. The printing ink may be cured on the film by means of physical activation (thermally, radiation-chemically). To this end the ink should undergo a high level of composite adhesion to the film substrate; this is vital for further processing. Print anchorage should be tested prior to further processing, using the cross-cut test (DIN EN ISO 2409). In the cross-cut test the print should achieve a rating of at least Gt 02.

In order to achieve a high level of composite adhesion/print anchorage it is necessary to practice appropriate selection and/or formulation of a printing ink as a function of the film material and/or to use a pretreatment technique for the print film. With preference here it is possible to choose corona treatment, which can be used in line with the printing operation. When a PET film is used, the surface tension should be adjusted to >50 mN/m. This can be measured using customary test inks.

Depending on the UV lamp, the UV curing should possess a percentage output adjustment between 50% to 100%, in order to ensure sufficient flexibility of the print for the subsequent processing operations.

In order subsequently to achieve a visible and sensorially perceptible impression on the laser label, the print should have a height of from 0.1 μm to 15 μm. It is preferred to choose a height from 1 to 5 μm. In addition, the esthetics and character of the print can be varied by means of the course of the printed dots.

For the realization of the invention it is also possible to use the other conventional printing techniques, which are known as relief printing processes. They include letter press and screen printing.

The support carrier sheet can be printed with a wide variety of designs, company logos or advertising for example. The printing of the support carrier sheet produces a negative impression on the visible surface of the first varnish layer of the label of the invention.

It is particularly preferred if in the first varnish layer the impression of the printed support carrier sheet is present as a depression of from 0.1 to 15 μm, preferably from 1 to 5 μm.

The label of the invention can be produced on an embossed support carrier sheet; for example, on a polyester sheet with a thickness of preferably from 25 to 100 μm, in particular 50 μm.

The embossing of the support carrier sheet can be carried out, for example, in varying thickness and/or depth using a metal embossing die (obtainable from Gerhardt). The depth of embossing is dependent on the set embossing pressure, which acts on the magnetic cylinder used in the embossing process, and on the nature of the counterpressure cylinder. Wrapping of the counterpressure cylinder (with tesaprint® or with a polyester film, for example) results in strong embossing.

Furthermore the embossing tool used may comprise holographic structures, so that the structure is reproduced on the varnish layer and produced as at least one hologram.

Therefore, the side of the embossing tool facing the materials to be embossed is shaped so as to give a structure which comprises a diffraction grating or a holographic image.

Since the hologram is produced in the varnish layer itself, there is no harmful multilayer structure, and the diffraction grating produced in this way possesses the same resistance and laserability as the varnish layer itself.

In one advantageous embodiment the support carrier sheet is composed of a permanently embossed thermoset or thermoplastic material, in particular polyester or polyamide.

In the process for producing such a label, the varnish layer is applied to the support carrier sheet and is cured under effectively oxygen-free conditions by exposure to a high-energy (150 to 500 kV) electron beam. In order to improve the adhesion between the two varnish layers that are preferably present, a slightly tacky surface can be brought about by means of a particularly low dose or by means of a certain amount of oxygen.

Atop this first layer the second is applied and is cured likewise by electron beams. This is followed, where appropriate, by coating with the adhesive and subsequently, if desired, by covering with the protective paper. Thereafter the polyester film is removed so that the free surface of the first, top layer is exposed. Depending on the form of the surface of the polyester film, this top layer is glossy, smooth, matt or embossed.

In a further advantageous embodiment, the carrier layer comprises an identification medium.

The diffusion properties of this identification medium can be deliberately selectively and locally varied with the aid of a contactless inscription process. Where the carrier sheet inscribed in this way is adhered to a workpiece, the identification medium diffuses toward the substrate surface, where it brings about a detectable reaction. This diffusion or reaction takes place only in those regions of the substrate surface in which the diffusion capability has been initiated, or not hindered, by the inscription operation. Accordingly, the carrier layer allows unambiguous inscription and identification of the workpiece.

The carrier layer is inscribed by means of a contactless method. Therefore, even in the plant environment, it is possible to obtain inscription which is insensitive to dirt, is rapid, and can be flexibly varied. The inscription of the carrier layer—and hence the change in the diffusion properties of the identification medium—can be carried out in particular by means of electromagnetic radiation.

For inscribing the carrier layer it is particularly advantageous to use a laser, which can be used to carry out both temperature-sensitive and light-sensitive inscription (in this context, the term “light” includes the entire region of the electromagnetic spectrum that is accessible to the laser). Lasers have the additional advantage of allowing high-contrast inscriptions with any desired choice of pattern, of allowing rapid changes to the inscription pattern, and of being reliable in use in the plant environment.

The identification medium selected is a substance which initiates a detectable reaction on the substrate. For this purpose, the identification medium must be matched to the material properties of the substrate. For instance, the identification medium may comprise a dye—which is matched to the substrate—which diffuses locally into the substrate surface and colors it. Alternatively, the identification medium may comprise a substance which undergoes a chemical reaction with the substrate surface. Of particular interest in this context are reactions in which the substrate surface is locally removed or locally expanded, so that following removal of the sheet the inscription of the substrate can be detected optically or else by touch. For the marking of metallic substrates, an identification medium which comprises an etching substance is particularly recommended.

In order to increase the level of theft protection, it may be advisable to choose an identification medium whose influence on the underlying substrate cannot be detected using the naked eye. This can be achieved with an identification medium which influences the absorption and reflection properties of the substrate, for example, only in the UV or IR region but not in the visible region.

The substrate contains no visible traces of the marking. The regions affected in this case continue to include the marking, which can easily be detected by informed security personnel with the aid, for example, of a UV or IR viewing device. In particular, the identification medium may be chosen such that the detectability, e.g., the UV fluorescence, is manifested only at certain wavelengths of the testing light.

For industrial use of the carrier layer, especially in the automotive industry, the sheet must be very robust with respect to the effects of temperature and light. These requirements can best be met if the security sheet has physical barriers which prevent the diffusion of the identification medium in the uninscribed state of the carrier layer.

During the inscription operation, these barriers are locally destroyed or weakened, so that in the areas thus weakened a selective diffusion of the identification medium can take place. In order to make the inscription highly resistant to temperature and/or light, the temperatures or light intensities which are required to destroy the barriers must be significantly higher than those to which the object to be marked is subject in the service state, even under extreme ambient conditions.

This prevention of the diffusion of the identification medium, which can be eliminated by contactless inscription, can advantageously be realized by microencapsulation of the identification medium in the carrier layer. The identification medium is enclosed in capsules whose walls may be composed, for example, of wax and/or fat and can be broken open by, for example, the local effect of heat in the relevant regions of the sheet, so that the identification medium contained therein is able to escape and, on coming into contact with the substrate, is able to diffuse into and/or react with said substrate.

The inscription can be given a particularly high temperature stability if the barrier is formed by a barrier layer which is arranged in sheet form between carrier layer and an adhesive layer and which, in the uninscribed state of the sheet, prevents the diffusion of the identification medium out of the carrier layer. Inscription of the carrier layer locally punctures the barrier layer, so that the identification medium is able to escape locally at these puncture points from the carrier layer and to diffuse into the adhesive layer.

Those regions of the barrier layer which remain undamaged in the course of inscription effectively prevent the diffusion of the identification medium and hence a reaction in these uninscribed regions.

It is possible on the one hand for the carrier layer to constitute a kind of matrix, in which the identification medium is embedded. Alternatively, the material of the carrier layer may itself constitute the identification medium, so that the carrier layer is composed of identification medium.

The heat-activatable adhesive preferably comprises

i) a thermoplastic polymer, with a fraction of from 30 to 90% by weight, especially 50% by weight,

ii) one or more tackifying resins, with a fraction of from 10 to 70% by weight, especially 50% by weight, the resins being, in particular, epoxy resins with hardeners, possibly accelerators as well, and/or phenolic resins,

iii) if desired, silverized glass beads,

iv) if desired, metalized particles,

v) if desired, nondeformable or difficult-to-deform spacer particles which do not melt at the reactivation temperature.

The reactive adhesive is a mixture of reactive resins which crosslink at room temperature and form a high-strength three-dimensional polymer network and of permanently elastic elastomers which counter the embrittlement of the product and so allow it to withstand sustained loads (compressions, extensions).

The elastomer is preferably from the group of the polyolefins, polyesters, polyurethanes and polyamides or may be a modified rubber such as, for example, nitrile rubber or else polyvinyl butyral, polyvinyl formal, polyvinyl acetate, or carboxyl- or epoxy-functionalized SEBS polymer.

Very particular preference is given to using nitrile rubber.

The preferred thermoplastic polyurethanes (TPUs) are known as reaction products of polyester- or polyetherpolyols and organic diisocyanates such as diphenylmethane diisocyanate. They are composed of predominantly linear macromolecules. Such products are available commercially mostly in the form of elastic granules; for example, from Bayer AG under the trade name “Desmocoll”.

By combining TPU with selected compatible resins it is possible to lower the softening temperature to a sufficient extent. Occurring in parallel with this, even, is an increase in the adhesion. Examples of resins which have proven suitable include particular rosins, hydrocarbon resins, and coumarone resins.

Alternatively, the reduction in softening temperature can be achieved by combining TPU with selected epoxy resins based on bisphenol A and/or F and a latent hardener.

By means of the chemical crosslinking reaction (on the basis of epoxides or phenolic resin condensation) of the resins at elevated temperature, high strengths are achieved between the reactive adhesive and the surface that is to be bonded.

The addition of the reactive resin/hardener systems also leads to a lowering of the softening temperature of the abovementioned polymers, which advantageously reduces their processing temperature and processing speed. The reactive adhesive is a product which is self-adhesive at room temperature or slightly elevated temperatures. When the product is heated, there is a also a short-term reduction in viscosity, as a result of which the product is able to wet even rough surfaces.

The compositions of the reactive adhesive can be varied widely by changing the type and proportion of the base materials. It is also possible to obtain further product properties such as, for example, color or thermal or electrical conductivity by means of specific additions of dies, organic and/or mineral fillers, such as silica, and/or powders of carbon and/or of metal.

The beads and/or soft conductive particles that may be present in the reactive adhesive and/or in the pressure sensitive and/or hotmelt adhesive permit conductivity in the z direction, and possibly in the x-y plane as well.

It is therefore particularly advantageous to use soft or elastic, spherical, metalized particles whose core is composed of metal or plastic and which are able to adapt to the thickness of the adhesive layer after compression, since the core can be deformed at the bonding temperatures. These particles may be metal beads, made of gold, nickel or silver, for example, silverized metal beads or, preferably, metalized or metal-coated polymer or elastomer beads, such as plastics beads, Styropor beads, the coating being carried out with a readily conductive metal (gold, silver, copper, nickel). Moreover, the metal or plastics beads may have been coated with conductive polymer.

In order to prevent excessive deformation, it is possible to admix spacer particles to the reactive adhesive and/or to the pressure sensitive and/or hotmelt adhesive. The spacer particles are of spherical geometry and are composed of a hard material which does not melt at the elevated bonding temperature and is difficult if not impossible to deform. The spacer particles may likewise be conductive, but should be harder than the metalized particles.

The pressure sensitive and/or hotmelt adhesive is, for example, a pressure sensitive adhesive as disclosed in DE C 15 69 898. The content of the entire disclosure of that patent is therefore part of this invention.

By way of example, an acrylate adhesive is applied at from 25 to 35 g/m².

The adhesive layer designed in accordance with the invention does not impair a label. The physical and chemical resistance properties are not altered. From the application standpoint, there is no detriment to the label in terms of inscribability with a laser or legibility of the information.

The label of the invention features a multiplicity of advantages which were not foreseeable in this way for the skilled worker.

Following application, the labels are quickly perceived, optically visible, and tactile.

Identification is possible without auxiliary means; in other words, an authenticity check can be made without UV or IR lamps, etc.

Since identification is unambiguous, the risk of a misassessment is low.

The label cannot be detached from the substrate without being destroyed.

Following activation of the reactive adhesive, the adhesion properties are substantially improved.

Without the use of suitable auxiliary means, nondestructive detachment of the labels, especially laser labels, is impossible owing to the high level of brittleness.

Nondestructive detachment is rendered impossible in particular as a result of the stripes arrangement of the reactive adhesive in the adhesive layer. The reactive adhesive forms a hurdle preventing the blade from severing the lower layers of the adhesive.

A particularly advantageous embodiment of the invention is illustrated with the aid of the figures described below, without wishing to subject the invention to any unnecessary restriction.

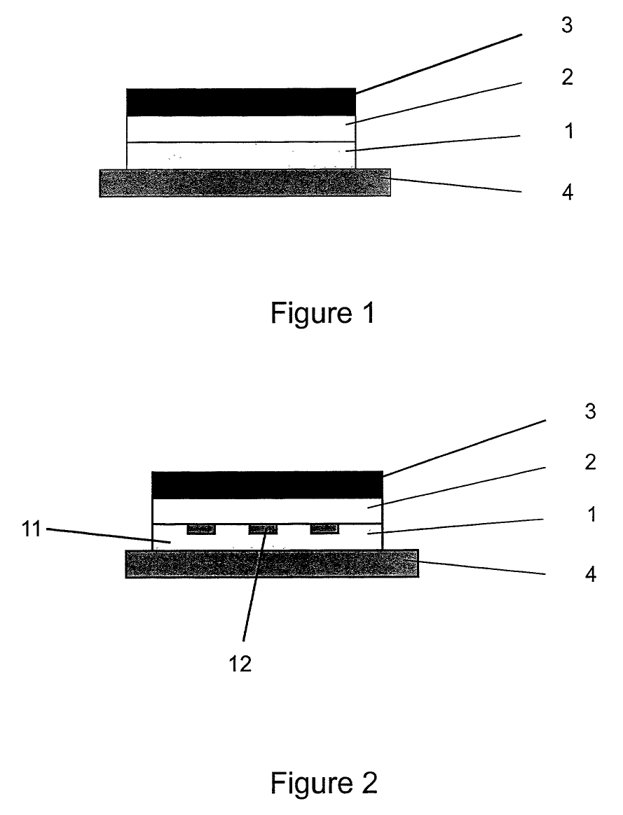

FIG. 1 shows the label with the heat-activatable (reactive) adhesive, present in a mixture with a pressure sensitive adhesive,

FIG. 2 shows the label with the heat-activatable (reactive) adhesive, which is arranged in the form of stripes on a varnish layer,

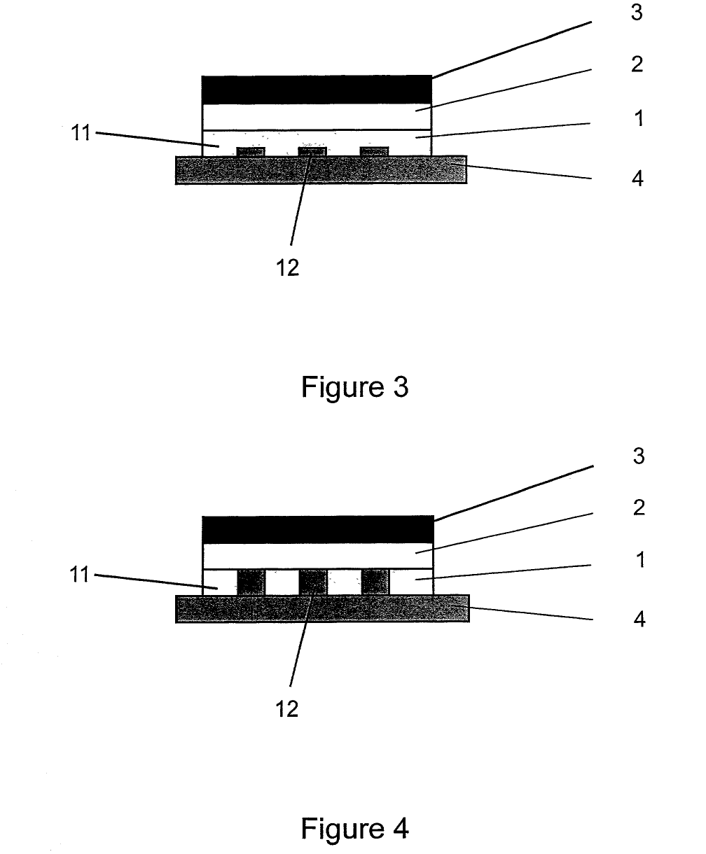

FIG. 3 shows the label with the heat-activatable (reactive) adhesive, which is arranged in the form of stripes on the pressure sensitive adhesive, and

FIG. 4 shows the label with the heat-activatable (reactive) adhesive, the pressure sensitive adhesive and the heat-activatable adhesive being arranged in stripes or dots.

FIG. 1 depicts the construction of a label in accordance with the invention, and the label with the heat-activatable (reactive) adhesive, which is present in a mixture with a pressure sensitive adhesive.

In this label the second varnish layer 3 is located on the thicker varnish layer 2, which is on a layer of an adhesive 1 that is bonded to the substrate 4.

The adhesive layer I is composed of a mixture of a pressure sensitive adhesive and the heat-activatable adhesive.

FIG. 2 differs from FIG. 1 only inasmuch as the adhesive layer 1 has a different structure.

The adhesive layer 1 is formed essentially of the pressure sensitive adhesive 11, on which three stripes of the reactive adhesive 12 are applied. The reactive adhesive 12 is therefore located between the varnish layer 2 and the pressure sensitive adhesive 12.

If an attempt is made to part the label from the substrate using a knife with a very narrow spine, the knife first of all enters the layer of the pressure sensitive adhesive 11. The blade of the knife remains at the first of the three stripes of the reactive adhesive 12. If the pressure is increased in order to move the knife on, a pressure is exerted, via the stripes, on the overlying varnish layer 2, and leads easily to the splitting of the varnish layer 2. The label is damaged and can no longer be detached from the substrate without the damage being evident.

In FIG. 3 the adhesive layer 1 is produced by printing or laminating the reactive adhesive 12 onto the pressure sensitive adhesive 11 in the form of stripes. The reactive adhesive 12 is therefore in direct contact with the substrate 4.

The particular feature of FIG. 4 is that in this case reactive adhesive 12 and pressure sensitive adhesive 11 have been arranged alternately in stripes on the varnish layer 2. One possible production process for the stripes is printing or lamination.

Prior to heat activation, the inserted stripes or dots do not exhibit permanent tack, so that the adhesive properties are somewhat poorer than in the case of a conventional label.

Following activation of the reactive adhesive, in contrast, the adhesion forces are substantially increased, so that it is impossible to detach the label.

### EXAMPLE

The purpose of the example below is to disclose a particularly advantageous label produced using a printed support carrier sheet so that on the surface of the label there are embossments which result in a further high security factor.

The support carrier sheet to be printed, in this case a polyester film (Hostaphan RN 75®) from Mitsubishi, is treated prior to printing, by corona treatment, in such a way as to produce the desired surface tension. This can be done using a VETAPHON Corona Plus DK—E-Treater ET 2—with an output of from 0.2 to 2.0 kW. For further processing it is advantageous to adjust the surface tension to >50 mN/m.

A cationically curable UV varnish, SICPA 360076 from SICPA, Aarberg, is used, which is tinted blue. The printing ink is optimized for processing by admixing 5% by weight of an agent which prevents it sticking to the cylinders.

Using an ARSOMA em 410 or 510 UV flexographic printing machine, the pretreated polyester film is printed at a machine speed of 30 m/min via a flexographic printing station. Precisely defined ink transfer to the flexographic printing plate is effective by means of a corresponding engraved roller in a negative doctor blade process. Thereafter, ink is transferred from the plate to the film substrate in an ink height of from 3 to 4 μm.

The ink applied to the film substrate is cured by means of powerful UV lamp tubes. The equipment used for this purpose is a GEW Micro UV station with a lamp output of 110 W/cm at a wavelength of 365 nm. The support carrier sheet is now ready for further processing.

A commercial polyurethane acrylate made from long-chain polyesterdiol, aliphatic diisocyanate, and terminal acrylic groups (molecular weight approximately 1500, functionality 2) is mixed with 20% of hexanediol bisacrylate to give a liquid with a high viscosity of approximately 10 Pa*s.

This is used to prepare:

a black paste A, by dispersing with 12% carbon black FCF (average particle diameter 23 μm) on a triple-roll mill, and

a white paste B, by dispersing with 45% of a rutile pigment stabilized with Al and Si (TiO₂ content 90%, density 3.9 g/cm³).

Paste A is coated in a thickness of 10 μm onto a biaxially oriented and embossed polyester film 50 μm thick and is cured by an electron beam of 350 keV with a dose of 1 Mrad under inert gas.

Thereafter, a white paste B is applied with a thickness of 50 μm and curing is again carried out with the electron beam under inert gas, with a dose of 3 Mrad.

To this product there is applied a pressure sensitive adhesive in accordance with DE 15 69 898 A1, so that the layer after drying has a thickness of 20 μm. The pressure sensitive adhesive is covered with commercial release paper.

The polyester film is then removed so that the black surface of the product, which carries embossments and is otherwise mirror-smooth, is revealed.

This surface can rapidly be inscribed with a barcode, for example, using a controllable output laser. The contrast is so high that the code can be read without error from a distance of more than 1 m using a reading device.

Heating of the material at 200° C. for one hour results in shrinkage of less than 10% in the lengthwise and transverse directions. Immersion in water and/or weathering in a weatherometer for 500 h results in no impairment.

What is claimed is:

1. A label with enhanced proof against counterfeiting, comprising at least one carrier layer with an adhesive layer on its underside, wherein the adhesive layer is composed of a pressure sensitive and/or hotmelt adhesive and a heat-activatable (reactive) adhesive.

2. The label as claimed in claim 1, wherein, in the adhesive layer, the pressure sensitive and/or hotmelt adhesive is in the form of a mixture with the heat-activatable adhesive.

3. The label as claimed in claim 1 or 2, wherein, in the adhesive layer, the pressure sensitive and/or hotmelt adhesive and the heat-activatable adhesive are arranged partially in stripes or dots.

4. The label as claimed in any of claims 1 to 3, wherein, in the adhesive layer, the heat-activatable adhesive is laminated or printed on the pressure sensitive and/or hotmelt adhesive partially in stripes or dots.

5. The label as claimed in any of claims 1 to 3, wherein, in the adhesive layer, the heat-activatable adhesive is laminated or printed, partially in stripes or dots, onto the carrier layer, especially the laser varnish layer, the pressure sensitive and/or hotmelt adhesive being coated on the modified carrier layer.

6. The label as claimed in any of claims 1 to 5, wherein the carrier layer is composed of a varnish, particularly of a cured varnish, preferably a radiation cured varnish, with particular preference of an electron beam cured polyurethane acrylate varnish.

7. The label as claimed in claim 6, wherein atop the varnish layer a second varnish layer is applied and is subsequently cured.

8. The label as claimed in claim 6 or 7, wherein the second varnish layer has a thickness of from 1 to 20 μm, in particular from 5 to 15 μm, and the varnish layer has a thickness of from 20 to 500 μm, in particular from 30 to 100 μm.

9. The label as claimed in any of claims 6 to 8, wherein the two varnish layers exhibit maximum color contrast to one another.

10. The use of a label as claimed in at least one of the preceding claims in automotive construction.
